(19) United States
(12) Patent Application Publication
(10) Pub. No.: US 2015/0360245 A1
(43) Pub. Date: Dec. 17, 2015

(54) SPRAY HEAD ASSEMBLY

(71) Applicant: Derjin (Hong Kong) Holding Company Limited, Central (HK)

(72) Inventor: Ya-Tsan Wang, HsinChu City (TW)

(21) Appl. No.: 14/302,429

(22) Filed: Jun. 12, 2014

(51) Int. Cl. B05B 1/30

(52) U.S. Cl. CPC B05B 1/3013

(57) ABSTRACT

A spray head assembly includes a press head, a nozzle, a plunge, a movable member and a resilient member. The press head has a space, a first connection portion and a press end. The nozzle is connected to the press head and has a second connection portion connected to the first connection portion. The plunge is inserted in an outlet of the nozzle has a seal end and a third connection portion. The movable member is located in the space and connected to the plunge. The movable member has a fourth connection portion which is connected to the third connection portion. The movable member is pushed by liquid. The resilient member is mounted to the tubular portion and biased between the restriction portion and push portion. When the press end is pushed, the liquid pushes the movable member so as to move the plunge to open the outlet.

### BACKGROUND OF THE INVENTION

(1) Fields of the Invention

The present invention relates to a spray head assembly, and more particularly, to a spray head assembly which automatically seals the outlet when not in use.

(2) Description of the Prior Art

The conventional spray head assembly is used widely in everyday living, such as used with lotion bottles, cosmetic liquid bottles, and cleaning agent bottles. The spray head assembly is connected to the bottle so that when the users pushes the press head, the liquid in the bottle is sucked and sprayed from the nozzle of the spray head assembly. However, the path that the liquid is ejected from is always open and air is in contact with the liquid so that the liquid is contaminated quickly and easily. The liquid can also easily dried because the air is directly in contact with the liquid.

The present invention intends to provide a spray head assembly which eliminates the shortcomings mentioned above.

### SUMMARY OF THE INVENTION

The present invention relates to a spray head assembly and comprises a press head having a space defined therein. A first connection portion is defined in the inside of the space, and a press end is defined in the top of the press head. A nozzle is connected to the press head and has a second connection portion which is connected to the first connection portion of the press head. The nozzle has an outlet and a restriction portion.

A plunge is inserted in the outlet and connected with the nozzle. The plunge has a seal end and a third connection portion respectively formed on two ends thereof. The seal end is removably engaged with the outlet.

A movable member is located in the space and connected to the plunge. The movable member has a fourth connection portion, a tubular portion and a push portion. The fourth connection portion is connected to the third connection portion. The push portion is pushed by liquid.

A resilient member is mounted to the tubular portion, and the first end of the resilient member is restricted in the restriction portion and the second end of the resilient member is stopped by the push portion. When the press end is pushed, the push portion is pushed by the liquid and the plunge is moved to remove the seal end away from the outlet.

Preferably, the nozzle has a tapered mouth.

Preferably, the push portion is a vertical surface which is pushed by the liquid.

Preferably, the plunge has a shank, and a path is defined between the outside of the shank and the inside of the nozzle.

Preferably, the resilient member is a spring.

Preferably, the press head has a fifth connection portion and a suction unit is connected to the fifth connection portion.

Preferably, the first connection portion and the second connection portion are connected to each other by threads or a snapping device.

Preferably, the third connection portion and the fourth connection portion are connected to each other by threads or a snapping device.

The primary object of the present invention is to provide a spray head assembly which has a plunge to seal the outlet of the nozzle when not in use, and the plunge is moved to open the outlet when the user pushes the press head of the spray head assembly.

Another object of the present invention is to provide a spray head assembly to effectively separate the liquid in the bottle from the air, dust or other foreign objects outside the bottle.

Yet another object of the present invention is to provide a spray head assembly which is suitable for the liquid with high viscosity.

Yet another object of the present invention is to provide a spray head assembly wherein the nozzle has a tapered mouth through which the outlet is defined. The tapered outlet is shaped to be matched with the tapered seal end of the plunge.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the spray head assembly of the present invention;

FIG. 2 is a cross sectional view of the spray head assembly of the present invention;

FIG. 3 shows that the plunge is moved to open the outlet when the press head is pushed, and

FIG. 4 shows that the outlet is sealed by the plunge which is moved back by the resilient member when the press head is released.

### DETAILED DESCRIPTION OF THE PREFERRED EMBODIMENT

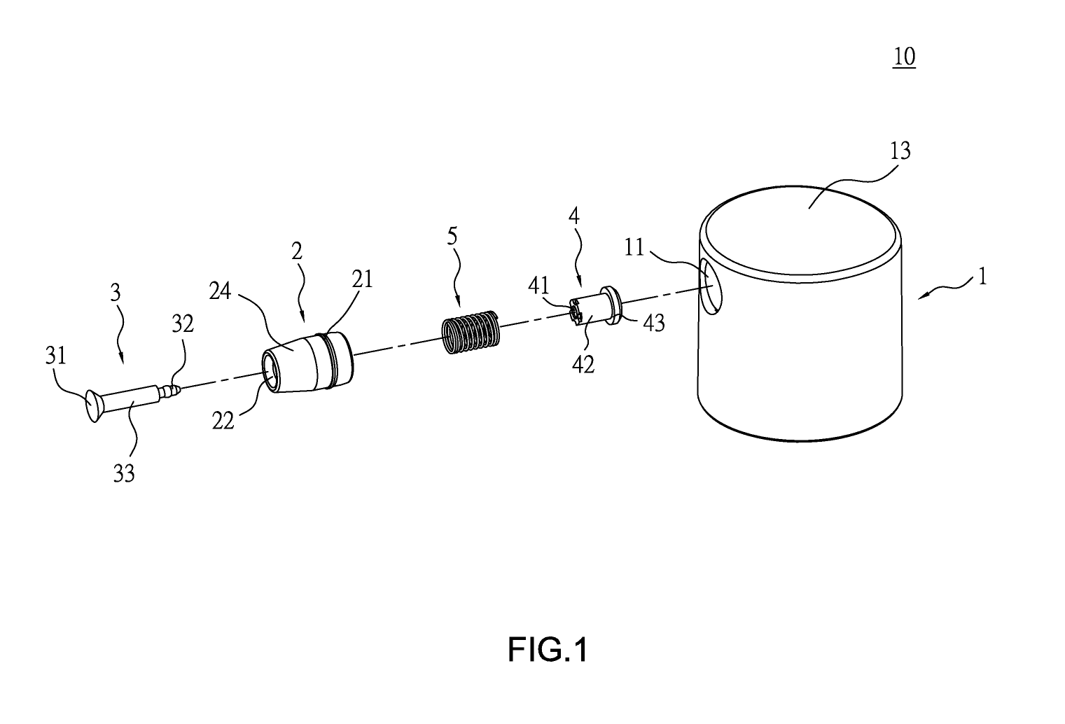

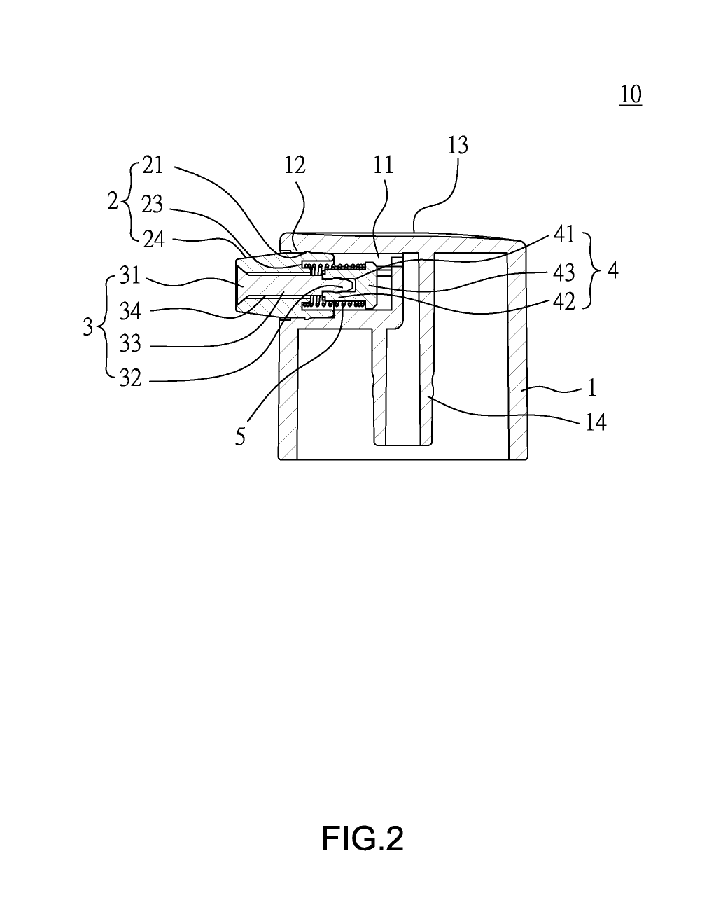

Referring to FIGS. 1 to 2, the spray head assembly 10 of the present invention is cooperated with a bottle in which liquid is received. The spray head assembly 10 comprises a press head 1, a nozzle 2, a plunge 3, a movable member 4 and a resilient member 5. The press head 1 has a space 11 defined therein, a first connection portion 12 defined in the inside of the space 11, and a press end 13 is defined in the top of the press head 1. The nozzle 2 is connected to the press head 1 and has a second connection portion 21 which is connected to the first connection portion 12 of the press head 1. The connection between the first and second connection portions 12, 21 can be vary by any known method, such as by threading or by a snapping device such as groove and ridge. The nozzle 2 has an outlet 22 and a restriction portion 23. The nozzle 2 has a tapered mouth 24 and the outlet 22 is defined through the tapered mouth 24. Preferably, the outlet 22 is a tapered outlet. The plunge 3 is inserted in the outlet 22 and connected with the nozzle 2. The plunge 3 has a seal end 31 and a third connection portion 32 respectively formed on two ends thereof. The seal end 31 is a tapered end and removably engaged with the outlet 22. Preferably, the plunge 3 has a shank 33, and a path 34 is defined between the outside of the shank 33 and an inside of the nozzle 2.

The movable member 4 is located in the space 11 and connected to the plunge 3. The movable member 4 has a fourth connection portion 41, a tubular portion 42 and a push portion 43. The fourth connection portion 41 is connected to the third connection portion 32. The connection between the third and fourth connection portions 32, 41 can be vary by any known method, such as by threading or by a snapping device such as groove and ridge. The push portion 43 is pushed by liquid. In this embodiment, the push portion 43 is a vertical surface which is pushed by the liquid. The resilient member 5 is mounted to the tubular portion 42. The first end of the resilient member 5 is restricted in the restriction portion 23 and the second end of the resilient member 5 is stopped by the push portion 43. Preferably, the resilient member 5 is a spring. When the press end 13 is pushed, the push portion 43 is pushed and the plunge 3 is moved to remove the seal end 31 away from the outlet 22.

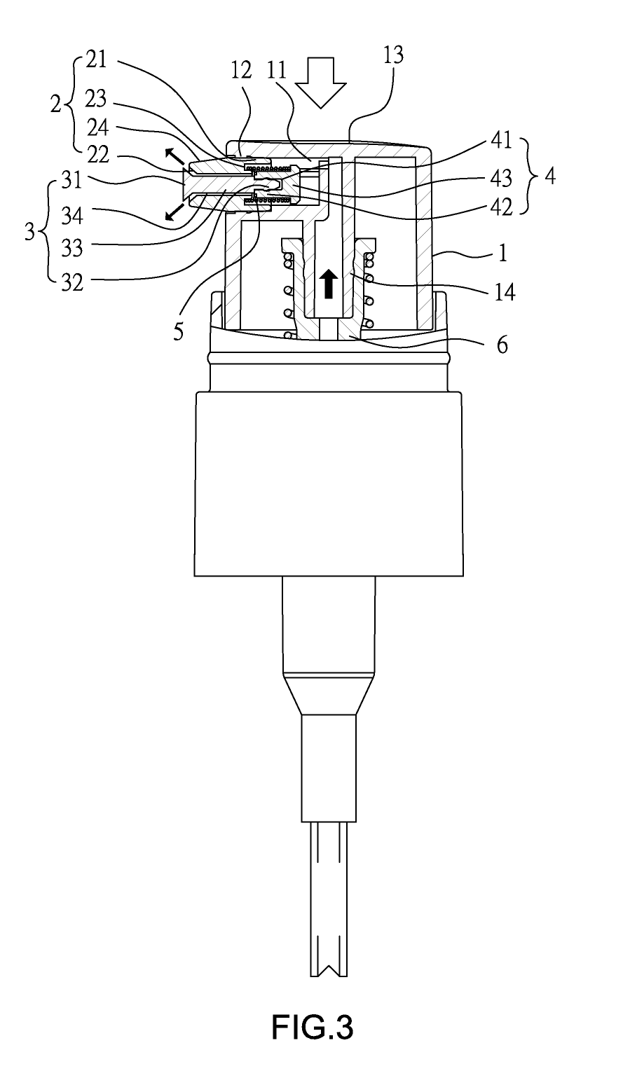

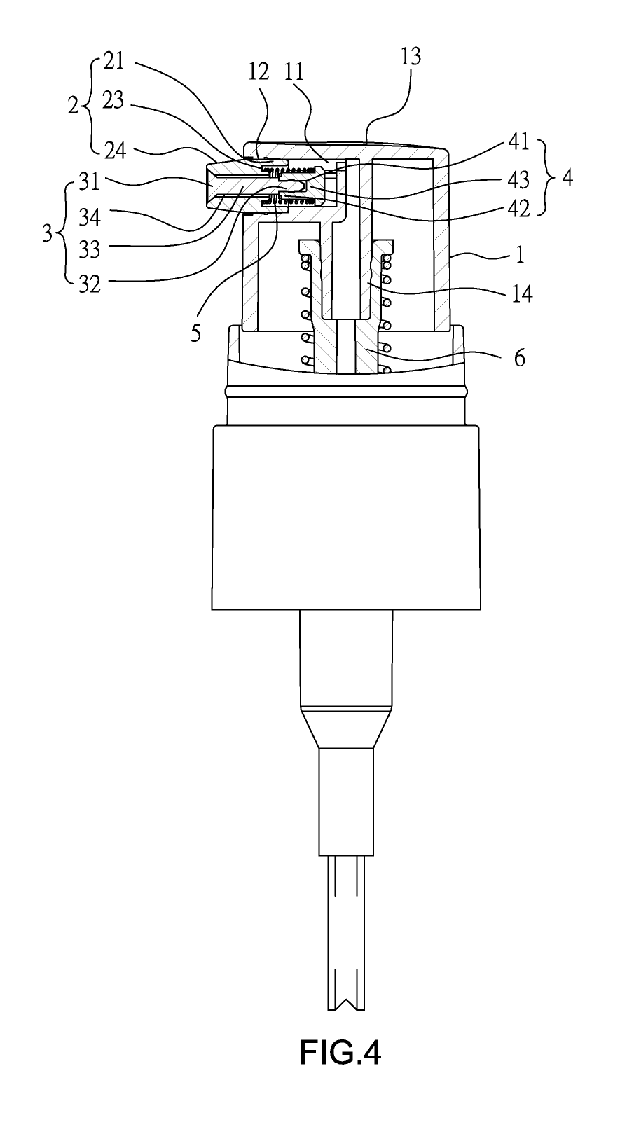

As shown in FIGS. 3 and 4, the press head 1 has a fifth connection portion 14 and a suction unit 6 is connected to the fifth connection portion 14. The liquid in the bottle can be sucked by the suction unit 6 and sprayed from the outlet 22 of the nozzle 2. When the press head 1 is pushed, the suction unit 6 sucks the liquid in the bottle. When the liquid applies a force that is larger than the resilient force of the resilient member 5, the liquid moves the movable member 4 so as to move the plunge 3. The movement of the plunge 3 allows the seal end 31 of the plunge 3 to remove from the outlet 22, so that the outlet 22 is opened and the liquid is sprayed from the outlet 22 as shown in FIG. 3.

When the user releases the press head 1, the resilient member 5 moves the plunge 3 so that the seal end 31 of the plunge 3 moves back to seal the outlet 22 again, the liquid is separated from the outside air.

The movable member 4 is moved by the pressure of the liquid and the movement of the movable member 4 move the plunge 3 to open and seal the outlet 22. When the seal end 31 of the plunge 3 seals the outlet 22, the liquid in the bottle is separated from the air, dust or other foreign objects outside the bottle. Therefore, the liquid is not dried and contaminated. The spray head assembly of the present invention is suitable for the liquid with high viscosity. The tapered seal end 31 effectively seals the tapered outlet 22.

While we have shown and described the embodiment in accordance with the present invention, it should be clear to those skilled in the art that further embodiments may be made without departing from the scope of the present invention.

What is claimed is:

1. A spray head assembly comprising:
a press head having a space defined therein, a first connection portion defined in an inside of the space, a press end defined in a top of the press head;
a nozzle connected to the press head and having a second connection portion which is connected to the first connection portion of the press head, the nozzle having an outlet and a restriction portion;
a plunge inserted in the outlet and connected with the nozzle, the plunge having a seal end and a third connection portion respectively formed on two ends thereof, the seal end removably engaged with the outlet;
a movable member located in the space and connected to the plunge, the movable member having a fourth connection portion, a tubular portion and a push portion, the fourth connection portion connected to the third connection portion, the push portion being adapted to be pushed by liquid, and
a resilient member mounted to the tubular portion, a first end of the resilient member being restricted in the restriction portion and a second end of the resilient member being stopped by the push portion, when the press end is pushed, the push portion is pushed and the plunge is moved to remove the seal end away from the outlet.

2. The assembly as claimed in claim 1, wherein the nozzle has a tapered mouth.

3. The assembly as claimed in claim 1, wherein the push portion is a vertical surface which is adapted to be pushed by the liquid.

4. The assembly as claimed in claim 1, wherein the plunge has a shank, a path is defined between an outside of the shank and an inside of the nozzle.

5. The assembly as claimed in claim 1, wherein the resilient member is a spring.

6. The assembly as claimed in claim 1, wherein the press head has a fifth connection portion and a suction unit is connected to the fifth connection portion.

7. The assembly as claimed in claim 1, wherein the first connection portion and the second connection portion is connected to each other by threads or by a snapping device.

8. The assembly as claimed in claim 1, wherein the third connection portion and the fourth connection portion is connected to each other by threads or by a snapping device.
